(19) United States
(12) Patent Application Publication
(10) Pub. No.: US 2007/0281752 A1
(43) Pub. Date: Dec. 6, 2007

(54) Case for Spectacles

(76) Inventor: Gene Lee Cheyenne Lewis, Watford (GB)

Correspondence Address: SMITH-HILL AND BEDELL, P.C., 16100 NW CORNELL ROAD, SUITE 220, BEAVERTON, OR, 97006, US

(21) Appl. No.: 10/568,233

(22) PCT Filed: Aug. 3, 2004
(86) PCT No.: PCT/GB04/03344

§ 371 Date: Feb. 14, 2006

(30) Foreign Application Priority Data
Aug. 14, 2003 (GB) 0319038.6

(51) Int. Cl. H04M 1/00

(52) U.S. Cl. 455/569.1

(57) ABSTRACT

A case for receiving a pair of spectacles formed integrally with at least an earpiece, a microphone, a rechargeable power source and a radio communication circuit. The case includes a charging circuit for recharging the power source of the spectacles.

### FIELD OF THE INVENTION

This invention relates to a case for receiving a pair of spectacles formed integrally with at least an earpiece, a microphone, a rechargeable power source and a radio communication circuit.

### BACKGROUND OF THE INVENTION

The popularity of cellular phones has led to several concerns regarding the safety of their use. Aside from the possible danger that exposure to electromagnetic radiation during prolonged use of a cellular phone may cause cancer, there is also a risk of road accidents if such phones are used while driving. A driver using one hand to hold a mobile phone to his ear compromises his ability to drive safely and legislation is therefore being passed in many countries to make the use of hand held phones illegal while driving.

For these and other reasons, it has already been proposed to provide cellular phones with hands free kits. These consist of an earpiece placed within or next to the ear and a mouthpiece that hangs down on a wire to lie on the chest of the user. The wire may then connect into the phone unit. This has the advantage that no hands need be used to support the phone, leaving the driver unencumbered to control the vehicle. It also results in the phone being located away from the user's head. Since electromagnetic radiation intensity follows an inverse square law, remotely locating the phone will reduce the exposure of the user to electromagnetic radiation emitted by the phone.

Though this still leaves a problem that functions need to be controlled, the use of voice recognition instead of a keypad allows the answering and making of calls to be performed without viewing a screen or touching a keypad, thereby making operation easier and safer when driving.

The advent of recent improved technology, namely Bluetooth®, has enabled a wireless connection between the phone and the hands free kit. The resulting hands free apparatus takes the form of an earpiece with workings which rest on the ear, having a boom which extends towards the mouth, for supporting a microphone.

While functionally adequate, such wireless hands free kits are somewhat bulky, and unattractive as well as being uncomfortable when used over long periods, due to their weight being supported entirely on one ear.

A proposed solution has been to incorporate such a hands free kit into into a pair of spectacles, thereby enabling the phone to be used comfortably while leaving the user with his hands free.

Incorporating hands free kit in a pair of spectacles, and in particular sunglasses which are intended to be included within the meaning of the term spectacles, effectively creates a dual purpose fashion accessory that is both attractive and functional. Since spectacles are supported by the ears, they enable easy and comfortable positioning of a suitably placed speaker or earpiece.

### OBJECT OF THE INVENTION

The present invention seeks to improve further on the technology of incorporating mobile communication equipment in spectacles.

### SUMMARY OF THE INVENTION

The present invention provides in its broadest aspect a case for receiving a pair of spectacles formed integrally with at least an earpiece, a microphone, a rechargeable power source and a radio communication circuit, wherein the case includes means for recharging the power source of the spectacles.

The radio communication circuit of the spectacles is intended to allow the spectacles to communicate with a remote unit which may not necessarily be a mobile telephone, though that is believed to be the primary application for the spectacles of the present invention. The remote unit may alternatively be a PDA, a portable or desktop computer, all of which are currently available with Bluetooth® technology.

As a further possibility, the communication circuit of the spectacles may itself function as a mobile telephone handset. However, to reduce the radiation hazard referred to above, it is preferred for it to act only as a hands free kit that communicates with a remote unit which itself acts as a telephone handset.

The remote unit with which the circuitry mounted in the spectacles communicates is preferably mounted within the case, thereby allowing the case to act as both mobile telephone and charger and case for the handsfree kit.

The term mobile telephone is used herein to refer either to a cellular phone or to a wireless telephone extension that communicates with a base unit connected to a land line.

It is preferred for the lenses of the spectacles to be photo-chromic. Because photo-chromic lenses darken automatically when exposed to bright light, they enable the spectacles to be used under all lighting conditions.

Mobile phones often have screens for displaying relevant information. In an embodiment of the invention, a display screen, for example and LCD screen, is incorporated into a lens of the spectacles.

The internal power source of the spectacles is preferably a rechargeable battery. A jack plug, coupling the spectacles to the case, may be provided to enable the battery to be charged, alternatively, the spectacles may be recharged by means of an inductive loop, simply by inserting them into the case.

It is possible to incorporate control buttons into the frame of the spectacles and these are preferably mounted on the inner side of the frame arms.

### BRIEF DESCRIPTION OF THE DRAWINGS

The present invention will now be described further by way of example with reference to the accompanying drawings in which:

FIG. 1 is a perspective view of a pair of spectacles,

FIG. 2 is a similar perspective view of an alternative design of spectacles of, and

FIG. 3 shows a case for the spectacles of FIG. 1.

### DETAILED DESCRIPTION OF THE PREFERRED EMBODIMENT

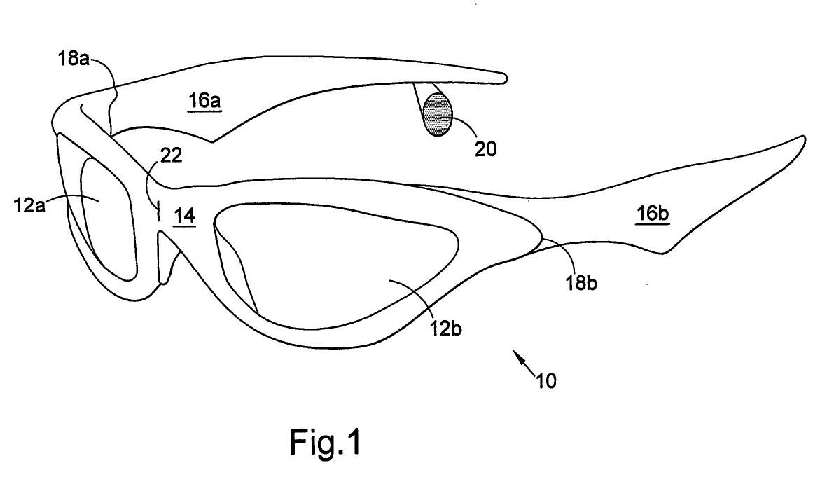

The spectacles 10 shown in FIG. 1, which in this example are sunglasses, are outwardly conventional in appearance. They comprise two lenses, 12a and 12b intended to be positioned in front of the eyes of a user. The lenses are supported by a frame 14 shaped in the usual manner to support the weight of the spectacles on the bridge of the nose. The frame, as is conventional, may be made of metal or a plastics material and its style may vary widely depending on the preference of the user, the spectacles illustrated being aimed at the sports market.

The frame 14 has two arms 16a and 16b folding about hinges 18a and 18b, respectively. The hinges allow the spectacles to be folded for easier storage when not in use. The arms 16a and 16b extend rearwards from the frame and rest above the ears of a user, to locate the lenses 12a and 12b in relation to the eyes.

A microphone 22 is incorporated into the bridge piece of the frame 14. Furthermore, an earpiece 20 intended for insertion into, or to lie next to, the ear of the user depends from either or both arms 16a and or 16b, as required by the user. The ear piece maybe be foldable or retractable so that it may be moved clear of the ear so as to minimise intrusion or any discomfort when the spectacles are not functioning as a hands free kit.

In order to function as a hands free kit, spectacles 10 require a signal and power. For this purpose, the frame 10 acts also serves to house a battery and a radio link (not visible in the drawing).

The radio link communicates with a mobile phone or a remote unit such as a PDA or a computer. This may be achieved via any of the several existing wireless protocols such as Bluetooth® or 802.11b.

Answering and making of calls with such arrangement can be achieved by means of voice activation which is commonly known in the art with reference to existing hands free kits.

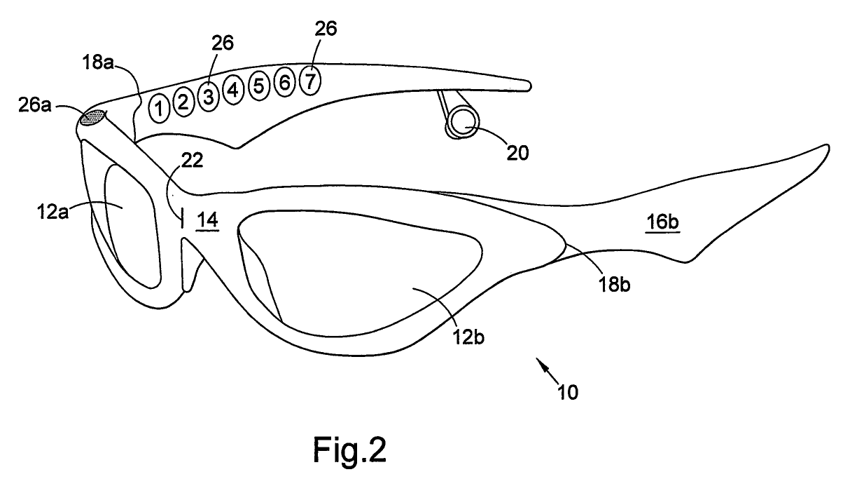

A further embodiment of the spectacles, shown in FIG. 2, incorporates an entire cellular phone into the frame 14 of the spectacles 10. Modern mobile phones have removed unsightly aerials and produced smaller technology which enables the microprocessor of the unit to be hidden within the frame, retaining the design of the spectacles. Similarly to the simpler hands free spectacles described in reference to FIG. 1, known voice recognition technology may be employed in order to control the basic features of the phone.

Alternatively, in order to operate the phone, the embodiment of FIG. 2 provides buttons 26, arranged on the inside of arms 16a and 16b. For further convenience, a primary function key 26a may be provided on the outside rim of the frames of the spectacles. Such a button can be easily reached whilst the spectacles are being used and may be programmed to provide the most important features of the phone simply by pressing one button.

Conventional mobile phones have an LCD display screen for indicating dialled numbers and other information such as battery and signal strength, such information may be displayed on a similar panel (not shown) located on the frame 14, or alternatively by incorporated an screen, such as an LCD screen, into lens 12a or 12b. A simpler version may employ coloured LEDs arranged on the frame of the spectacles just within the field of view of the user. These provide a lower cost method of indicating a lack of signal or low battery.

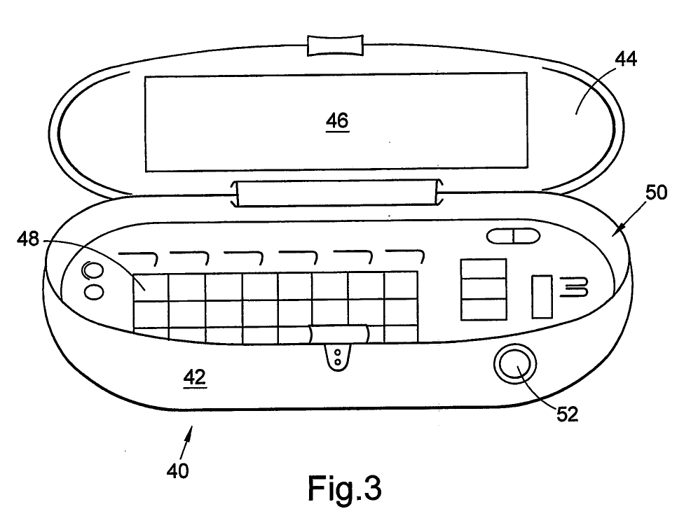

The spectacles have a rechargeable battery mounted in the frame 14. In the present invention, the charging station used to recharge the battery is built into the carrying case for the spectacles. While it would be possible when using a case such as that shown in FIG. 3, a wire could be used to establish a connection between the spectacles and the charging circuit in the case, it is preferred to use an inductive loop 50 to charge the battery in the spectacles without the need for cumbersome connecting wires. The case 40 derives its own power by a jack plug connection 52 with a mains power source.

The carrying case or hard case 40, as shown in FIG. 3, has a container section 42 and hinged a lid 44. In addition to serving as a means for recharging the internal battery of the spectacles, it may act in the case of the embodiment of FIG. 1 as the remote unit. Hence, the carrying case may comprise a mobile telephone. For such features and others described in more detail below, the case 40 would require its own internal rechargeable power supply.

Where the spectacles 10 incorporate a cellular phone, the hard case 40 may act as more than simply a charger. Modern cellular phones have many functions such as settings for ringing tones and volumes, calendars, diaries, calculators, and web access via WAP, GPRS, 3G and other protocols. With such control over functionality, simple voice control is not sufficient to enable access to all the features.

The hard case 40 may provide access to these functions by interacting with the spectacles 10, either by wire or more preferably, wireless communication. The case doubles as the carrier of many of the functions of the phone and therefore is provided with means for data entry and retrieval. Such means may include a keyboard 48 and a display screen (or touch screen) 46, arranged conveniently around the inside of the container section 42 and lid 46.

The hard case 40 can provide features not normally associated with a cellular phone. These include a GPS antenna and receiver, which combined with a database and software, can allow the user to find his way whilst driving, or alternatively as a pedestrian trying to navigate on foot around an unfamiliar city. This can be achieved by looking directly at the display in the case, or by viewing and listening to whatever instructions are transmitted to the spectacles 10.

Further features may of course be employed such as internet access via the case 40 as well as the features of any PDA (personal digital assistant) computer, with the added benefit that any or all the information can be conveniently uploaded, or displayed via wireless communication with the spectacles 10.

With such hardware already in place, the hard case is capable of providing many more features, such as acting as a games console, or with provision of an aerial, and a suitable tuner, a radio or television. Equally with sufficient memory, either internal or in the form of memory sticks, the hard case may be easily configured to function as a portable MP3 player, or any other format of music or video. Again, use of the spectacles conveniently enables these features to be employed silently through the ear piece, therein avoiding offending surrounding people, yet conveniently without the use of wires.

Similarly, the case may also be capable of playing footage taken by camcorder or acting as a portable display screen to view still pictures taken from a remote digital camera. Alternatively the case itself can serve as a self contained camera, already having suitable display and control means.

With the potential for this number of features, the case is a likely target for theft. It would therefore be prudent to include security features. These could consist of the use of personal identification numbers, or potentially finger print or retinal scanners.

1. A case for receiving a pair of spectacles formed integrally with at least an earpiece, a microphone, a rechargeable power source and a radio communication circuit, characterised in that the case includes a charging circuit coupled to the spectacles by an inductive loop for recharging the power source of the spectacles.

2-3. (canceled)

4. A case as claimed in claim 1, further having a wireless link for communicating with the spectacles in order to upload or download information.

5. A case as claimed in claim 1, further having means for displaying and means for inputting information.

6. A case as claimed in claim 1, further having a GPS aerial and receiver for enabling the case to be used as a navigation device.

7-14. (canceled)

15. A case as claimed in claim 1, further having means to enable the case to function as a pocket computer.

16. A pair of spectacles formed integrally with at least an earpiece, a microphone, a rechargeable power source and a radio communication circuit, in combination with a case for receiving the spectacles, wherein the case includes a charging circuit coupled to the spectacles by an inductive loop for recharging the power source of the spectacles.

17. A combination as claimed in claim 16, wherein the radio communication circuit of the spectacles serves to establish a wireless connection between the earpiece and microphone and a nearby remote unit.

18. A combination as claimed in claim 16, wherein the radio communication circuit of the spectacles serves to enable the spectacles to perform as a self-contained mobile or cellular telephone.

19. A combination as claimed in claim 16, wherein the means for recharging the spectacles is supplemented by a solar panel mounted on the case.

20. A combination as claimed in claim 16, wherein the spectacles are provided with control buttons for operating the radio communication circuit.

21. A combination as claimed in claim 16, wherein the earpiece depends from an arm of the spectacles.

22. A combination as claimed in claim 16, wherein the spectacles further comprise a display screen connected to the radio communication circuit.

23. A combination as claimed in claim 22, wherein the display screen is incorporated into a lens of the spectacles in the form of an LCD.
